(19) United States
(12) Patent Application Publication
(10) Pub. No.: US 2007/0289445 A1
(43) Pub. Date: Dec. 20, 2007

(54) Compact and efficient pressure swing oxygen concentrator

(76) Inventors: Mei Hua, Nanjing (CN); Cao Guo Chen, Shanghai (CN)

Correspondence Address: WEIDE & MILLER, LTD., 7251 W. LAKE MEAD BLVD., SUITE 530, LAS VEGAS, NV, 89128, US

(21) Appl. No.: 11/454,959

(22) Filed: Jun. 15, 2006

(51) Int. Cl. B01D 53/02

(52) U.S. Cl. 95/96; 96/121

(57) ABSTRACT

A gas separator works on a pressure swing principle. The separator includes multiple sieve beds, preferably five arranged in pentagonal fashion about a centerline, and a control valve. The control valve includes a rotor and a stator. The rotor is mounted for rotation relative to the stator. One part of the rotor allows pressurized gas to flow to the stator and thereon to one or more, and preferably two, of the sieve beds for separation. Another part of the rotor blocks flow of gas through the stator to or from one or more of the sieve beds, and yet another part of the rotor allows waste gas to flow from one or more of the sieve beds back through the stator to an exhaust. The separator may be used as part of a system. In a method of use, sieve beds are cycled between adsorption, de-pressurization, purging, and pre-pressurization phases.

### FIELD OF THE INVENTION

The present invention relates to gas concentrators which operate on a “pressure swing” principle, and more particularly to such a concentrator which is compact and efficient.

### BACKGROUND OF THE INVENTION

Gas concentrators or separators which operate on a pressure swing absorption (“PSA”) principle are well known. In general, the PSA principle relates to the ability of an adsorpt to adsorb different components of a gas in varying or different degrees. In general, gaseous materials are introduced to the adsorptive material, such as a sieve bed of such material, at the high pressure. The more readily adsorptive component(s) of the gaseous material is adsorbed and a high purity stream of the least adsorptive component(s) of the gaseous material is collected as a product from the process. As pressure is reduced in the bed, a stream rich in the more adsorptive of the gaseous components is released as waste and removed from the exhaust. The adsorbent in the sieve bed is re-generated for the next cycle. This PSA principle is used as a method of separation gasses, such as to generate high purity or “concentrated” oxygen, nitrogen or hydrogen.

FIG. 1 shows a traditional two sieve bed PSA system. This design uses two sieve beds to generate oxygen in alternate cycles. Compressed air is introduced to the bed A1 from the entry point at O1. A lower layer of control valves and timing electronics control the PSA cycle time for bed A1. Separated oxygen is collected at an oxygen reservoir indicated at O2. When the PSA cycle time is up, the electronic timing circuit will switch off bed A1 and turn to bed A2 for the next PSA cycle. In the interim time, part of the separated or “generated” oxygen will be used to flush waste gasses (such as nitrogen) from bed A1.

The two bed design has a limitation that each of the beds must be large to provide a large oxygen volume output, and therefore the workload upon a compressor which supplies air to the sieve beds for separation is placed under a large and heavy load. Also, a large oxygen reservoir is necessary to smooth out the oxygen output pressure change. In particular, in such a system, the swing in pressure during the cycle of gas charge and discharge is rather radical and is saw tooth like. However, a larger reservoir causes the system to be unresponsive to change. For example, when a patient selects a higher oxygen flow rate (such as by changing the desired delivery rate from 2 LPM to 5 LPM), it will take sometime before the oxygen output is stabilized. In addition, this system does not allow effective purging and re-pressurizing of the sieve beds. Therefore, the separation efficiency level is relatively low, resulting in a lower concentration or purity of the desired end product. In addition, the output pressure level of the system is relatively unstable.

PSA systems using a greater number of sieve beds have been developed for industrial use. These designs rely on complex valve controls. Such designs have proven to have a high efficiency in gas separation and offer greater stability in system pressure. The main disadvantages include the complexity of the design, high cost in development and production, and the fact that multiple valve controls tend to breakdown frequently due to heavy usage.

With a smaller PSA based device/oxygen concentrator, separating nitrogen, carbon dioxide and water vapor from air results in high purity level of oxygen. Such devices have great utility, such as in serving patients with long term respiratory illness by improving the quality of their lifestyle. Currently, home use PSA oxygen concentrators are being manufactured by several companies.

Ideally, home use concentrators should offer the following attributes:

Minimal in size and weight for greater mobility

Able to provide stable and high concentration level of oxygen on a continuous basis

Reliable and user friendly

Low noise level

Consume a low level of power, resulting in a relatively low operating cost

Most of the home use concentrators today utilize a two sieve bed configuration in conjunction with a multi-way pneumatic valve control using an electronic timing and control circuit, which is rather complicated and unreliable. Due to the increasing demand of home use concentrators, current devices have improved in regard to their reliability and stability. U.S. Pat. Nos. 5,814,130, 5,814,131 and 5,807,423 all disclose a 2 sieve bed configuration with a rotary valve rather than an electronic pneumatic valve. It appears such a rotary valve is far simpler and is more reliable. Furthermore, it can reduce the overall concentrator size and weight. Nevertheless, the rotary valve disclosed therein and others which are known cannot eliminate the instability of the machine's working pressure and are not capable of improving the gaseous separation efficiency of a two bed system.

U.S. Pat. No. 5,366,541 discloses a separator which includes a rotary valve with a multiple sieve bed (12 sieve beds) configuration. This combination does indeed provide a more stable pressure environment within the cycle. However, this design uses equalization at the entry end of the sieve beds, which substantially lowers or reduces efficiency. In theory, a higher number of sieve beds in a design should produce a more stable pressure environment and result in better output gas. On the downside, more sieve beds will gain additional size, weight and production cost.

There remains a desire for an oxygen concentrator or separator with reduced size, weight and cost, while still providing a high level of performance, efficiency and reliability.

### SUMMARY OF THE INVENTION

The invention comprises a gas separation system which includes at least one gas separator, embodiments and features of gas concentrators or separators, and methods of gas separation.

One embodiment of the invention comprises a gas separator which includes sieve beds and a control valve. Preferably, the separator has five sieve beds, each sieve bed having a bottom end and a top end, the sieve beds arranged in a generally pentagonal relationship around a centerline. Separated or product gas is delivered through a product gas outlet from each sieve bed to one or more product reservoirs.

Flow of gas to each sieve bed for separation and flow of waste gas from each sieve bed is controlled by a control valve. In one embodiment, the control valve comprises a housing having a gas inlet leading to an interior space. The control valve also includes a stator and a rotor which are preferably located in the housing.

The stator has a top and a bottom. Preferably, a single exhaust gas passage leads through the stator from top to bottom. Gas delivery passages also extend through the stator from the top to the bottom thereof (preferably five in number when there are five sieve beds).

The rotor is mounted for rotation relative to the stator, and is preferably located adjacent to the stator. The rotor is configured to cooperate with the stator to control the flow of gasses through the control valve. In one embodiment, the rotor has a first cut-away portion which, when aligned with at least one of the gas delivery passages in the stator, allows gas to flow from the interior space of the housing into that passage or passages to the corresponding sieve beds. The rotor has a second portion which, when aligned with at least one of the gas delivery passages in the stator, blocks the flow of gas to or from the sieve beds corresponding to that passage or passages. The rotor includes at least a third portion which, when aligned with at least one of said gas delivery passages in the stator, allows gas to flow through the passage or passages from the sieve bed or beds back through the exhaust passage through the stator.

In one embodiment, the stator is a ceramic plate which is mounted in an inset in a top of a lower portion of the housing. The rotor is likewise a ceramic plate which is mounted in a chamber defined at a bottom of an upper portion of the housing. Means, such as a motor, are provided for rotating the rotor relative to the stator.

In a preferred embodiment, gas to be separated is delivered to bottom end or portion of each of the sieve beds. Separated product is delivered from the top end or portion of the sieve beds.

The separator of the invention may be used in a system. Such a system may include a compressor for pressurizing gas for delivery to the separator. Air which is delivered to the separator may be filtered to remove dirt and water. Separated product may also be filtered and may be humidified before delivery to a user.

Another aspect of the invention is a method of separating a gas. In one embodiment, air or other gas is selectively delivered to the sieve beds of a separator using a control valve. The gas is preferably delivered in a manner such that each sieve bed goes through a cycle including the steps of pre-pressurization, adsorption, co-current de-pressurization, counter-current pressurization, and purging. In the adsorption phase, gas is delivered at high pressure to the bed for separation. In the co-current de-pressurization phase, the source of pressurized air is removed from the sieve bed, but adsorption continues. In the counter-current pressurize phase, remaining gas which was delivered to the sieve bed for separation is released, lowering the internal pressure in the sieve bed. In the purge phase, a small portion of product gas flows back through the sieve bed to aid in regeneration of the bed. In the pre-pressurization phase, product gas is allowed to flow back to the sieve bed in a manner raising the internal pressure of the bed. At that point, the cycle starts again, with gas being delivered to the sieve bed for separation.

In one embodiment of the method, at least two sieve beds are in the adsorption phase at all times. In a preferred embodiment, there are five sieve beds. Two beds are in the adsorption phase and the other three are in one of the other four phases of the cycle, the beds offset from one another in the cycle. Preferably, the method is accomplished by rotating a single rotor relative to a stator to control the flow of gasses to and from the sieve beds.

The invention is a compact and very efficient means for separating gasses and is particularly suited to home medical and similar uses.

Further objects, features, and advantages of the present invention over the prior art will become apparent from the detailed description of the drawings which follows, when considered with the attached figures.

### DESCRIPTION OF THE DRAWINGS

FIG. 1 illustrates a two bed pressure swing absorption gas separation system in accordance with the prior art;

FIG. 2 illustrates a separation system in accordance with one embodiment of the invention, the system including a gas separator in accordance with an embodiment of the invention;

FIG. 3A is a side view of a gas separator in accordance with the present invention;

FIG. 3B is a top view of the gas separator illustrated in FIG. 3A;

FIG. 4A is a cross-sectional side view of one embodiment of a control valve of the separator illustrated in FIG. 3A;

FIG. 4B is a top view of the valve illustrated in FIG. 4A;

FIG. 5A is a top view of a static plate of the valve illustrated in FIG. 4A;

FIG. 5B is a cross-sectional side view of the static plate illustrated in FIG. 5A taken along line 5B-5B therein;

FIG. 6A is a bottom view of a rotating plate of the valve illustrated in FIG. 4A;

FIG. 6B is a side view of the rotating plate of the valve illustrated in FIG. 4A;

FIG. 6C is a top view of the rotating plate of the valve illustrated in FIG. 4A;

FIG. 7A is a top view of a rotating plate and static plate assembly; and

FIG. 7B is a cross-sectional side view of the assembly illustrated in FIG. 7A.

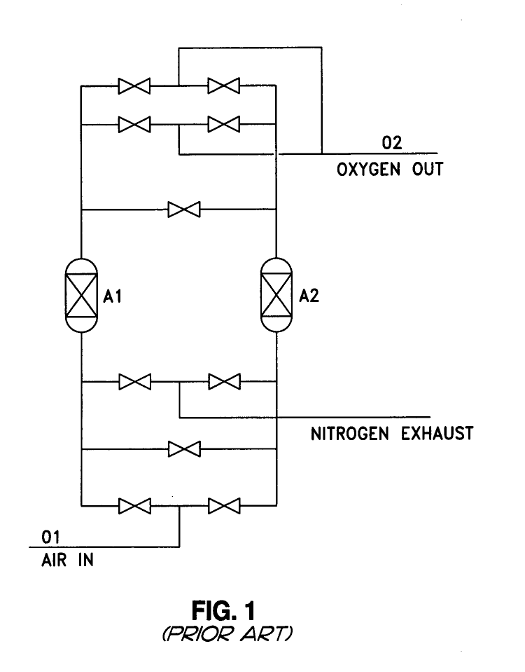

### DETAILED DESCRIPTION OF THE INVENTION

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

In general, the invention comprises gas separation systems, gas separators and methods of separating gas. One aspect of the invention is a system including a gas separator. The separator includes multiple sieve beds and a rotary valve. The rotary valve is configured to selectively deliver gas to the sieve beds for separation, and to de-pressurize, purge and then pre-pressurize the beds for the next adsorptive cycle. The rotary valve is configured so that each of the beds in the system are offset from one another in the cycle. In a preferred embodiment, at least two beds are in the adsorptive phase at all times.

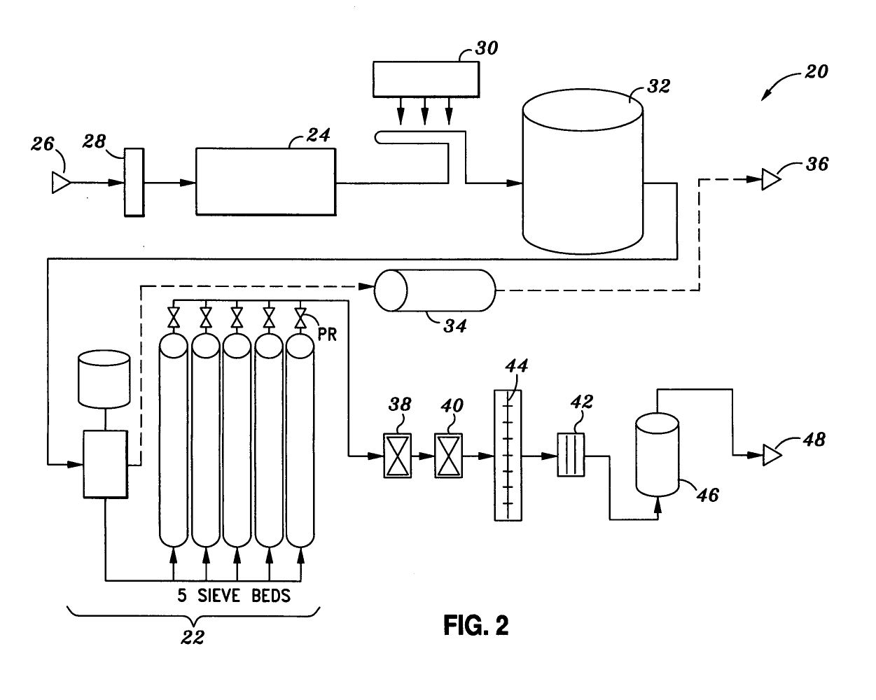

One embodiment of the invention will be described with reference first to FIG. 2. FIG. 2 illustrates, in diagrammatic form, one embodiment of a gas separation system 20 which includes a gas separator 22. As illustrated, the system 20 is particularly useful as an oxygen concentrator for home medical use. The gas separator 22 is preferably a five (5) sieve bed, PSA-type gas separator with a rotating valve. It will be appreciated that the system 20 may have other configurations, as may the gas separator 22 used therewith.

A compressor 24 obtains air from an intake 26 and provides that air at high pressure to the system 20. In a preferred embodiment, the air 26 is atmospheric or “room” air. Of course, other sources of product, such as air or other gas to be separated, may be utilized. The air may be filtered, such as with a 0.3 micron filter 28, to remove particulate matter such as dust and fume. A silencer (not shown) may also be used to lower the in-take noise.

A fan coil 30 may be used to remove moisture from the compressed air. The fan coil 30 may be utilized to lower the temperature of the incoming air, causing moisture to condense from the air for collection. The compressed air may be delivered to a storage tank 32. Additional moisture may be condensed and collected from the air at the storage tank 32.

The compressed air is then introduced to the separator 22. One or more embodiments of a separator 22 in accordance with the invention is detailed below. In a preferred embodiment, the separator 22 is utilized to separate oxygen from the air. In this process, substantially pure oxygen is delivered as the desired output or product. Nitrogen and other gases are generated as exhaust or waste product. As indicated above, the separator of the invention could be utilize to separate or concentrate other product from an incoming product supply.

The oxygen may be collected in a reservoir (not shown in FIG. 2). The waste gas, such as nitrogen, may be delivered to an exhaust. The waste gas may be passed through a silencer 34 before being delivered to an exhaust port or point 36.

The oxygen may be delivered through a one-way valve 38 which ensures that the sieve beds of the separator 22 are sealed from atmospheric moisture and pollution when the system is not in operation. The separated or generated oxygen then goes through the regulator valve 40 to lower the output pressure, such as to about 0.04-0.05 MPa. The oxygen may also pass through a filter 42, such as a 0.2 micron filter, to further remove any unwanted particles and ensure the oxygen is clean.

A flow-meter 44 may be used to regulate the oxygen output to a desired flow rate. For example, as detailed below, the oxygen may be delivered to a breathing unit associated with a respiratory patient. The flow-meter or flow regulator may be used to regulate the flow to the patient. Lastly, the oxygen may be passed through a humidifying device 46 to add moisture thereto (so that it is not so dry, such as in the case where it is being delivered directly to the lungs of patient), before the oxygen is delivered to an output 48. The output 48 might be tube, port or the like, such as might be connected to a supply line leading to a respiratory device or the like.

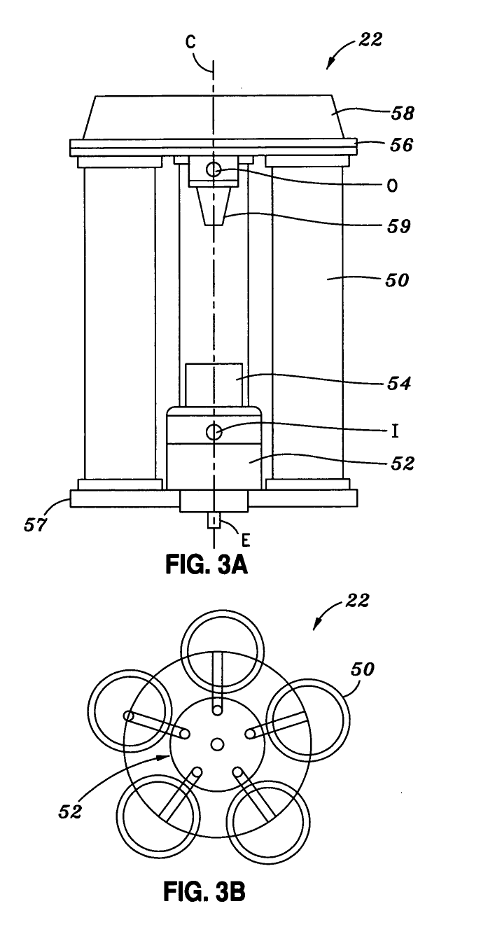

One embodiment of a concentrator or separator 22 in accordance with the invention will now be described in greater detail with reference to FIGS. 3-7. As illustrated in FIGS. 3A and 3B, the separator 22 has a modular form and includes a plurality of sieve beds 50, a control valve 52 which is preferably of the rotating type which is driven by a motor 54, a module cover 56 and a module base 57, an oxygen reservoir 58, a pressure regulator 59, an air inlet I, an oxygen outlet O, and an exhaust or waste gas outlet E.

The sieve beds 50 are preferably of any type now known or later developed which are useful in separating oxygen or other desired product from an incoming product supply, preferably atmospheric or room air. Preferably, the sieve bed 50 comprises a material which readily absorbs nitrogen, but not oxygen, thereby permitting oxygen to pass there through.

Preferably, the separator 22 includes five (5) sieve beds 50. As illustrated, the sieve beds 50 are preferably located in a pentagonal orientation around a centerline C or center of the separator 22, thereby providing a small profile or size for the separator 22.

The sieve beds 50 have a top or proximal end and a bottom or distal end. The bottom or distal end of each bed 50 is located at the module base 57. As detailed below, air is provided to the bottom end of each sieve bed 50. The air is then separated, with oxygen (or other desired product) being delivered to the top end of each sieve bed 50. The top ends of the beds 50 correspond to the module top or cover 56. Oxygen passing through the beds 50 is delivered to the reservoir 58.

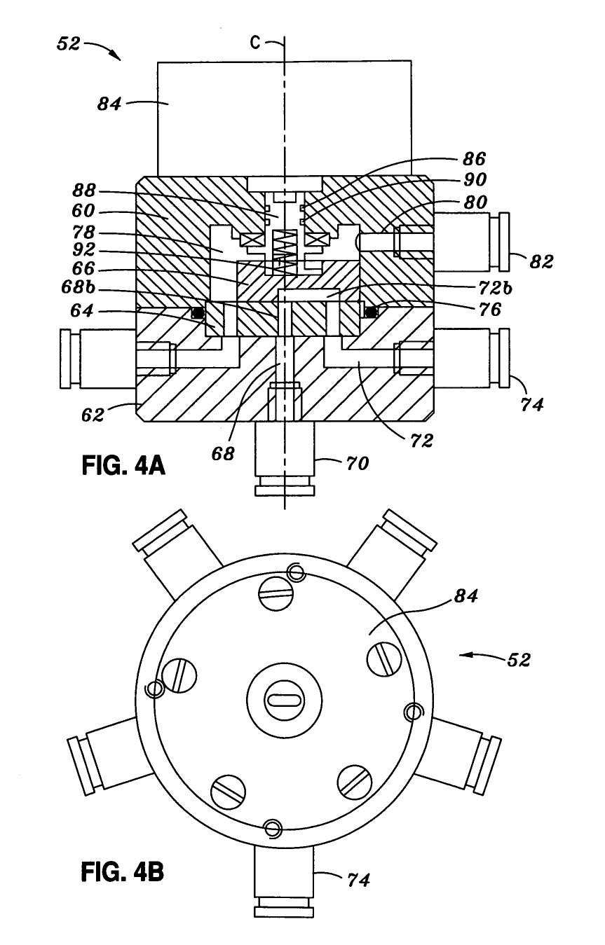

The separator 22 includes means for selectively delivering air or other product to each bed 50 for separation. In a preferred embodiment, the means comprises the control valve 52. In that the control valve is, in a preferred embodiment, a rotating valve, the control valve is also referred to herein as a rotating valve 52. One embodiment of the rotating valve 52 of the invention will be detailed with reference to FIGS. 4A and 4B.

In general, the valve 52 comprises five (5) main elements or portions. The valve 52 includes a housing. In a preferred embodiment, the housing comprises an upper housing 60 and a lower housing 62. The valve 52 also comprises a static plate or stator 64, a rotating plate or rotor 66, and means for moving the rotating plate 66. In one embodiment, as illustrated in FIG. 3A, the valve 52 may be located in a protective housing.

As illustrated, the lower housing 62 has a top and a bottom. In one embodiment, the lower housing 62 is generally cylindrical in shape and is a generally solid body. The lower housing 62 may have a variety of configurations, however. In a preferred embodiment, the lower housing 62 defines a depression or inset in the top thereof. As illustrated, the static plate 64 preferably sits within this depression. When the static plate 64 is generally cylindrical in shape, the inset or depression is preferably similarly shaped, so that the static plate 64 fits tightly within the lower housing 62.

A waste gas exhaust passage 68 extends through the lower housing 62 from the top to the bottom thereof. As illustrated, the waste passage 68 terminates at the inset and is preferably arranged to align with a mating passage in the static plate 64 (described below). As illustrated, a nipple 70 may be located at the exit of the waste gas exhaust passage 68 from the bottom of the lower housing 62, such as to permit connection of a gas line thereto.

The lower housing 62 also defines an air passage 72 corresponding to each of the sieve beds 50. Thus, in the embodiment where the separator 22 includes five (5) sieve beds, there are preferably five (5) air passages 72. As illustrated, each air passage 72 leads from the inset through the lower housing 62 to a side or peripheral portion thereof. In this orientation, each air passage 72 turns ninety (90) degrees along its path. A nipple 74 or other connector may be located at the exit of each air passage 72 from the lower housing 62.

As described above, the static plate 64 sits at least partially within the inset in the top of the lower housing 62. In one embodiment, the static plate 64 is a disc-like (generally circular peripheral shape) member. As illustrated, one or more seals 76, such as O-rings, may be located between the static plate 64 and the lower housing 62 to form an air-tight seal there between.

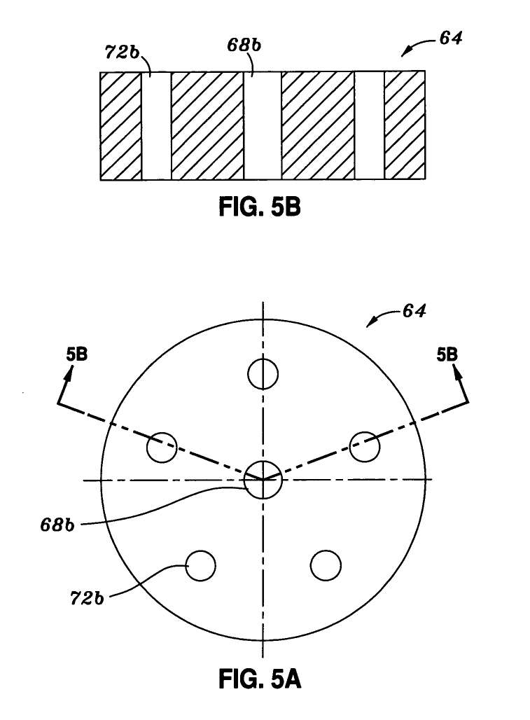

Referring also to FIGS. 5A and 5B, the static plate 64 defines passages there through which correspond to the air and waste gas passages of the lower housing 62. In particular, the static plate 64 similarly defines a waste gas passage 68b which is aligned with the waste gas passage 68 in the lower housing 62. The static plate 64 also defines five (5) air passages 72b which correspond to the five (5) air passages in the lower housing 62. Each of these passages 68b, 72b extends in alignment with the corresponding passage in the lower housing 62 and extends there through from a bottom of the static plate 64 to a top thereof.

Referring again to FIGS. 4A and 4B, the upper housing 60 is positioned above the lower housing 62. The upper housing 60 has a top and a bottom. The bottom of the upper housing 60 rests upon the top of the lower housing 62. In one embodiment, the upper housing 60 is generally cylindrical in shape.

The upper housing 60 defines a chamber 78. The chamber 78 extends inwardly from the bottom thereof, such than when the upper housing 60 is mounted to the lower housing 62, the chamber 78 is generally closed.

An air intake passage 80 leads from the exterior of the upper housing 60 there through to the chamber 78. In one embodiment, this passage 80 is a generally straight, horizontally positioned passage. A nipple 82 or other fitting may be located at the exterior of the upper housing 60, such as for connection to an air pipe. Preferably, compressed air is delivered through the passage 80 to the chamber 78.

As illustrated, the chamber 78 is preferably sized to accept the rotating plate 66 therein. In one embodiment, the chamber 78 is generally positioned about a centerline C through the valve 52. The rotating plate 66 is designed to rotate about this centerline C within the chamber 78.

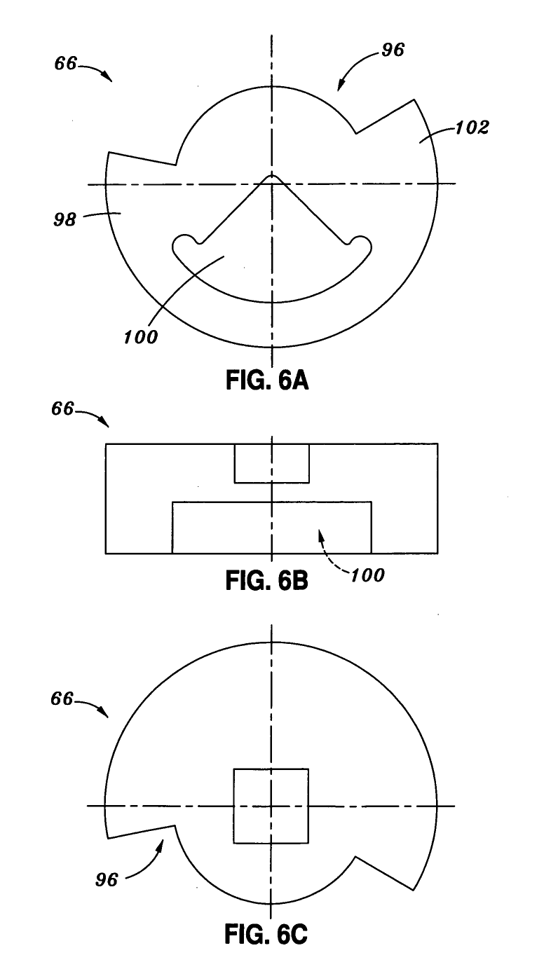

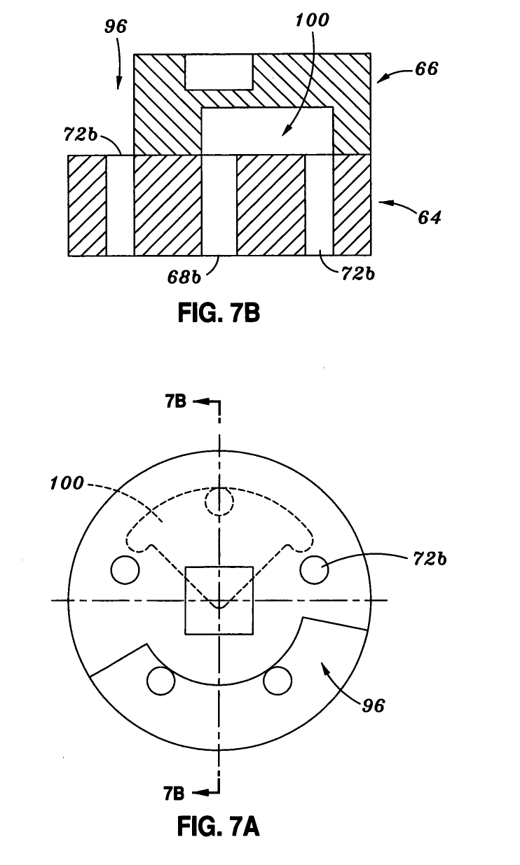

The rotating plate 66 is a generally disc-shaped member. The rotating plate 66 is located in the chamber 78 and positioned adjacent the static plate 64, and more preferably is placed on top of the static plate 64 in direct and sealing contact therewith. The rotating plate 66 is designed to cooperate with the static plate 64 to selectively open and close the air and waste gas passages 68b, 72b through the static plate 64 which leads to the corresponding passages 68, 72 through the lower housing 62. Additional details of the rotating plate 66 will be provided with reference to FIGS. 6 and 7 described in more detail below.

As indicated, means are provided for selectively rotating the rotating plate 66. In one embodiment, this means comprises a motor 84. The motor 84 is preferably located above the upper housing 60. In one embodiment, the upper housing 60 defines a drive rod passage 86 from the top thereof through to the chamber 78. The passage 86 is preferably positioned along the centerline C.

The motor 84 is preferably an electrically-powered, synchronous motor. The motor 84 moves a drive rod 88 which is connected to the rotating plate 66. The drive rod 88 extends from the motor 84 through the drive rod passage 86.

In one embodiment, one or more seals 90, such as O-rings, are located between the drive rod 88 and the upper housing 60 to seal the space there between. In addition, one or more bearings 94 may be located around the drive rod 88, such as near the top of the chamber 78 in the upper housing 60, to rotationally support the drive rod 88.

Biasing means, such as a spring 92, preferably provide a pre-loading force to hold the rotating plate 66 in place. As illustrated, the spring 92 is a coil-spring which is located at least partially between the drive rod 88 and the rotating plate 66.

In one embodiment, at least the static plate 64 and rotating plate 66 are constructed of ceramic. This has the advantage that the plates are air-tight, hardwearing and self lubricating.

The rotating plate 66 will now be described in more detail with reference to FIGS. 6A-6C. The rotating plate consists of 4 functional areas. A first area 96 defines a compressed air entry area. As detailed below, this area allows compressed air to flow from the chamber 78 to one or more of the air passages 72b in the static plate 64 which allows compressed air to enter the corresponding sieve beds and start the PSA cycle. A second area 98 is a co-current de-pressurization area. This area 98 prevents compressed air from being transmitted to the sieve beds 50. A third area 100 is a waste gas flushing channel. This area allows waste gas to pass from one or more sieve beds 50 to pass therefrom through the air passage 72 in the lower housing 62 to the waste gas passage 68 (via the mating passage 68b in the static plate 64). The last area 102 is a pre-pressurizing area. This area again prevents compressed air from entering corresponding air passages leading to the sieve beds 50 and prevents waste gas from leaving the corresponding sieve beds 50.

As illustrated, the second and fourth areas 98, 102 are defined by generally solid portions of the rotating plate 66 which effectively block air or waste gas flow. In one embodiment, the first area 96 comprises an inset area at the periphery of the rotating plate 66 (inset relative to the shape of the rotating plate 66 if it were entirely circular or cylindrical in shape). The third area 100 comprises an inset or depression formed in the bottom of the rotating plate 66.

FIGS. 7A-7B illustrates the relationship between the static plate 64 and the rotating plate 66. As described in more detail below, the rotating plate 66 is configured to selectively cooperate with the static plate 64 to control: (1) the flow of compressed air to and from each sieve bed and (2) control the flow of waste product from each sieve bed.

As illustrated, as the rotating plate 66 rotates, the third area 100 selectively aligns with one or more of the air passages 72b through the static plate 64. When this occurs, the air passage 72b through the static plate 64 is placed in communication with the waste passage 68b, thereby allowing waste gas to flow from the one or more sieve beds 50 (corresponding to the air passage(s) 72(b)) to the waste gas exhaust from the valve 52. As detailed below, one advantage of the invention is the simplicity of the valve and passage configuration. As indicated, the same passages which are utilized to deliver gas for separation are used to deliver waste gas back to the valve for routing to the exhaust.

In addition, as the rotating plate 66 rotates, the first area 96 selectively aligns with one or more of the air passages 72b through the static plate 64. When this occurs, compressed air which is delivered to the chamber 78 (see FIG. 4A) can pass through the air passage 72b in the static plate 64 to the air passage 70 leading to one or more of the sieve beds 50.

Operation of the separator 52 will now be described in more detail. In general, each sieve bed 50 undergoes a PSA cycle which includes the following phases.

One phase is the “adsorption” phase. In accordance with this phase, high pressure gas or other product is delivered to a sieve bed for separation. The gas or other product is separated by the sieve bed. As detailed above, where the gas is atmospheric or room air, the sieve bed may be configured to separate the oxygen from the remaining gasses (primarily nitrogen). The separated gas is delivered through the one or more delivery holes or passages, such as to the product gas reservoir.

This phase will be described relative to one of the sieve beds 50 of the system 20 described above. With specific reference to the embodiment separator 22 detailed above, in this step, compressed air is delivered through the air passage 80 to the chamber 78 of the valve 52. When the first area 98 of the rotating plate 66 is aligned with the air passage 72b in the static plate 64, pressurized air flows through the static plate 64, through the corresponding air passage 72 in the lower housing 62, to the sieve bed 50.

Another phase is “co-current de-pressurization” phase. In this phase, the source of compressed air or other product is removed from the sieve bed. Separated product, such as oxygen, continues to be generated and be released from the sieve bed through a top regulating exit hole. The gas pressure within the sieve bed will gradually decrease down to very close to atmospheric pressure.

This phase will be described relative to one of the sieve beds 50 of the system 20 described above. With specific reference to the embodiment separator 22 detailed above, in this step, the rotating plate 66 is oriented so that the second portion 98 covers the air passage 72b which leads through the static plate 64 and thereon to the sieve bed 50. As such, the supply of compressed air is cut off from that sieve bed. The already delivered air, which is at a high pressure, continues to be separated as it passes through the sieve bed 50. As oxygen is separated and delivered from the sieve bed, the gas pressure in the sieve bed decreases.

Another phase is the “counter-current pressurization” phase. During this phase, the remaining gas in the sieve bed is released back through the entry hole, thus further lowering the internal gas pressure. At this time, adsorptive gas element starts to release from sieve bed.

This phase will be described relative to one of the sieve beds 50 of the system 20 described above. With specific reference to the embodiment separator 22 detailed above, in this step, the rotating plate 66 is oriented so that the third portion 100 the air passage 72 from the sieve bed 50 (which connects with the air passage 72b through the static plate 64) with the waste gas passage 68b which leads through the static plate 64 and the waste gas passage 68 through the lower housing 62, to the waste gas outlet. At this time, gas which was delivered but not separated, and waste product (i.e. product remaining after separation) can flow from the sieve bed 50 to the waste gas outlet, thus lowering the pressure within the sieve bed 50.

Another phase is the “purge” phase. During this phase, a small portion of the product gas enters or flows back into the sieve bed to help re-generate the molecule sieve and prepare the sieve for the next cycle. As this product gas flows back, it purges waste and unseparated gas.

This phase will be described relative to one of the sieve beds 50 of the system 20 described above. With specific reference to the embodiment separator 22 detailed above, in this step, the rotating plate 66 remains oriented in a position where the waste gas can escape or exhaust from the sieve bed 50. However, some product gas re-enters the sieve bed (essentially flowing backwardly, as from the top to the bottom of the sieve beds of the valve 52 as described). This product gas purges nitrogen and other separated gas from the sieve bed from that bed back through the valve 52.

Lastly, another phase is the “pre-pressurization” phase. During this phase, the air or product entry to the sieve bed is again closed. A small portion of the less adsorptive gas element (such as oxygen) enters from the regulating hole to start pressurizing the sieve bed and ready the bed for the next adsorption in the next cycle.

This phase will be described relative to one of the sieve beds 50 of the system 20 described above. With specific reference to the embodiment separator 22 detailed above, in this step, the rotating plate 66 is oriented so that the fourth portion 102 again covers the air passage 72 which leads through the static plate 64 and thereon to the sieve bed 50. As this time, as product gas continues to enter the sieve bed, the gas pressure in the sieve bed increases.

In the preferred embodiment of the invention, the separator 22 has five (5) sieve beds 50. The rotating plate 66 is rotated so that each of the sieve beds 50 goes through the above-described five phase cycle each time the rotating plate 66 makes a full cycle (i.e. full 360 degree rotation). Because various cycles are defined by the areas of the rotating plate 66, the sieve beds are simultaneously in different of the phases, depending upon the relative position of the rotating plate 66 to the stator 64 (and thus relative to the delivery passages leading to the sieve beds).

One example of the cycle sequence of each sieve bed according to time is shown in the following table:

| Bed/ | | | | | | |
|---|---|---|---|---|---|---|
| Stage | 1 | 2 | 3 | 4 | 5 | 6 |
| A | Adsorption | Adsorption | Co-current | Counter- | Purge | Pre- |
| | | | de- | current | | pressurize |
| | | | pressurize | pressurize | | |
| B | Pre- | Adsorption | Adsorption | Co-current | Counter- | Purge |
| | pressurize | | | de-pressure | current | |
| | | | | | pressurize | |
| C | Purge | Pre- | Adsorption | Adsorption | Co-current | Counter- |
| | | pressurize | | | de- | current |
| | | | | | pressurize | pressurize |
| D | Counter- | Purge | Pre- | Adsorption | Adsorption | Co-current |
| | current | | pressurize | | | de- |
| | pressurize | | | | | pressurize |
| E | Co-current | Counter- | Purge | Pre- | Adsorption | Adsorption |
| | de- | current | | pressurize | | |
| | pressurize | pressurize | | | | |

This configuration has a number of benefits. First, there are always two sieve beds in the adsorption phase, and only one sieve bed has a bigger difference in pressure at switching time. This ensures that the stability of output gas pressure of the system. Hence the flow, as well as the concentration, of the product gas remains stable.

In accordance with the invention, the cycle time may be adjusted by changing the speed of the rotating plate. Notably, the time of each step or phase of the PSA cycle can be adjusted by the position and/or angular extent of the portions of the rotating plate (i.e. the “absorption” phase can be extended by increasing the size of the cut-away portion 96 of the plate). As one example, to deliver a flow rate of 5 LPM of the product gas, the cycle time may be around 15-30 seconds, which corresponds to a rotating plate rotational speed of about 2-4 rpm.

The system, separator and method of the invention have a number of additional features and advantages. One advantage is that air is well filtered and passed through a silencer to the compressor. The compressor then generates a stream of high pressure compressed air. This compressed air may be cooled and passed through a container for condensation to remove excess moisture before entering the separator. Inside the separator, the rotating plate always exposes two air passages leading through the static plate to two corresponding sieve beds. Nitrogen, water and carbon dioxide (or other products, as desired) are adsorbed on the molecule sieve. Oxygen, the less adsorbed gas element, will be produced through the regulator hole at top of the sieve bed as the product gas. The product gas will be collected at the oxygen reservoir (pressure at about 0.1 MPa) and further regulated to about 0.04-0.05 MPa before passing out for patient use.

Other advantages of the system and method is that providing a stable production gas (such as oxygen) output pressure and flow rate. The system and method also have a high gas separation efficiency, such that a smaller mass of adsorpt, such as molecule sieve, needs to be used to produce the same volume and concentration of oxygen than prior systems and devices. The system and method are also very responsive to change—such as when the desired output is changed from a lower volume to higher volume oxygen output.

The system and method operate with small compressor pressure variation (in the range of +/−0.02 MPa) as compared to traditional 2 bed systems (+/−0.05 MPa). This reduction in pressure variation prolongs the life of compressor as well as reduces noise level of the entire system, which is crucial for patients under medical treatment.

It will be appreciated that the system and method of the invention may have other configurations than specifically illustrated and described. For example, the separator of the invention might be utilized with a system which differs from that illustrated in FIG. 2. The method of the invention might be implemented with a separator which is different than that specifically illustrated.

The separator of the invention may also have configurations other than as specifically illustrated while still being configured to implement the method of product separation. Various aspects of the invention, including aspects of the separator, may have applicability to other products or methods. For example, the control valve might be used with separators otherwise having other configurations.

The separator might be configured, for example, with multiple product gas reservoirs or a separate product gas reservoir. The control valve might be used with a separator having other numbers of sieve beds. The sieve beds might be configured other than as illustrated (for example, be cross-sectionally square rather than circular).

In one embodiment, the stator might be integral with the lower housing, rather than being a separate element which is mounted in an inset thereof. The passages may have a variety of shapes, and the passages might comprise tubes, pipes or other members defining generally closed or contained flow paths.

One advantage of the embodiment separator described and illustrated is its simplicity. The separator employs a minimal number of components and has few moving components. The passage configuration of the separator allows for five distinct sieve bed phases, even though only a single passage leads to each sieve bed. Instead of multiple passages like in prior art designs, the configuration of the invention allows the separator to have a less complex and more compact configuration. As detailed above, for example, waste gas is routed back from the sieve beds to the control valve (and there beyond to an exhaust point) using the same passages as which deliver product to be separated. In addition, the control valve can be located at the bottom of the separator close to the bottom of the beds, and the product gas can be stored at the top of the beds, providing a compact configuration (since cross-passages and the like, as are common in other designs, do not need to be provided between the ends of the beds).

The rotor/stator combination is particularly advantageous in that it allows the sieve beds to cycle through the five phases merely by rotating the rotor relative to the stator. No other valves or other elements are needed to control the gas flow (of delivery or waste gas).

It will be understood that the above described arrangements of apparatus and the method there from are merely illustrative of applications of the principles of this invention and many other embodiments and modifications may be made without departing from the spirit and scope of the invention as defined in the claims.

What is claimed is:

1. A gas separator comprising:
five sieve beds, each sieve bed having a bottom end and a top end, said sieve beds arranged in a generally pentagonal relationship around a centerline of said separator;
a product gas reservoir;
a product gas outlet leading from each of said sieve beds to said product gas reservoir;
a gas control valve, said gas control valve comprising:
a housing;
a gas inlet leading to an interior of said housing;
a stator having a top and a bottom, an exhaust gas passage leading from said top through said stator to said bottom and five gas delivery passages leading from said top through said stator to said bottom, said stator located in said housing; and
a rotor located in said housing adjacent said stator, said rotor mounted for rotation relative to said stator, said rotor having a first cut-away portion which, when aligned with at least one of said five gas delivery passages in said stator, allows gas to flow between said chamber and said at least one gas delivery passage in said stator, at least a second portion which when aligned with at least one of said five gas delivery passages in said stator blocks the flow of gas through said at least one gas delivery passage, and at least a third portion which when aligned with at least one of said five gas delivery passages in said stator allows gas to flow through said at least one gas delivery passage to said exhaust passage through said stator.

2. The gas separator in accordance with claim 1 wherein said housing defines at least one exhaust passage leading from said exhaust gas passage through said stator to an exterior of said housing.

3. The gas separator in accordance with claim 1 wherein said control valve includes means for rotating said rotor.

4. The gas separator in accordance with claim 1 wherein said means for rotating comprises an electric motor.

5. The gas separator in accordance with claim 1 wherein said housing defines five gas flow passages leading from said five gas delivery passages through said stator to an exterior of said housing.

6. The gas separator in accordance with claim 1 wherein said rotor and stator comprise ceramic plates.

7. The gas separator in accordance with claim 1 wherein said housing comprises an upper housing and a lower housing.

8. The gas separator in accordance with claim 7 wherein said lower housing has a top and a bottom, said top defining an inset, said stator located in said inset.

9. The gas separator in accordance with claim 7 wherein said top housing has a top and a bottom, said bottom defining an inset, said inset being enclosed to form said chamber when said top housing is mounted to said bottom housing.

10. The gas separator in accordance with claim 1 wherein said five gas delivery passage through said stator lead to said five sieve beds.

11. The gas separator in accordance with claim 1 wherein said product gas outlets are located and said product gas reservoir are located at a top of said separator.

12. A gas separator comprising:
five gas separating sieve beds, said sieve beds having a bottom end and a top end, said sieve beds arranged in a pentagonal relationship around a centerline;
a control valve comprising a upper housing having a top and a bottom and a lower housing having a top and bottom, said bottom of said upper housing positioned adjacent said top of said lower housing, said top of said lower housing defining an inset, a stator mounted at least partially in said inset, said stator defining five air flow passages leading there through to five delivery passages leading through said lower housing and a single exhaust passage leading there through to a single exhaust passage leading through said lower housing, said upper housing defining an inset at least bottom, said inset forming a generally enclosed chamber when said upper housing is positioned adjacent said lower housing, a rotor rotatably mounted in said chamber, at least a portion of said rotor positioned against said stator, said rotor having a first solid portion configured to obscure one or more of said air flow passages leading through said stator, a second peripheral cut-away portion which does not obscure one or more air flow passages through said stator when aligned therewith, and a third inset portion configured to connect at least one of said air flow passages through said stator with said single exhaust passage when aligned therewith, a gas inlet leading through said upper housing to said chamber, and a motor having a drive shaft extending through said upper housing into engagement with said rotor to rotate said rotor;
a flow path leading from each of said five delivery passages through said lower housing to said bottom end of each of said sieve beds;
a product reservoir located at said top ends of said sieve beds; and
a product delivery passage leading from said top end of each sieve bed to said product reservoir.

13. The gas separator in accordance with claim 12 wherein said stator and rotor are constructed of ceramic.

14. The gas separator in accordance with claim 12 wherein said five air flow passages and said single exhaust passage leading through said stator are generally vertically extending.

15. The gas separator in accordance with claim 12 wherein said control valve is positioned along said centerline between said sieve beds.

16. A method of generating a gas product of at least a product gas from a gas stream including said product gas and at least one additional gas comprising:
providing a gas separator including at least three sieve beds and a control valve;
delivering said gas stream under pressure to said control valve;
controlling a position of a rotor of said control valve so that a first position of said rotor allows said gas stream to be applied to at least two sieve beds in an adsorption phase, to at the same time prevent said gas stream from being applied to at least one sieve bed and prevent waste gas from flowing from said at least one sieve bed, and at the same time to allow waste gas to flow from at least one sieve bed; and
delivering product gas from said at least three sieve beds to a product reservoir.

17. The method in accordance with claim 16 wherein said controlling step comprises rotating said rotor.
